(19) United States
(12) Patent Application Publication
(10) Pub. No.: US 2002/0158177 A1
(43) Pub. Date: Oct. 31, 2002

(54) Adjustable support pole for double pane windows

(76) Inventor: Orville Hill, Compton, CA (US)

Correspondence Address: Richard W. Goldstein, 2071 Clove Road, Staten Island, NY, 10304, US

(21) Appl. No.: 09/844,587

(22) Filed: Apr. 27, 2001

(51) Int. Cl. F16M 11/00

(52) U.S. Cl. 248/354.5; 248/157; 248/161; 248/125.1

(57) ABSTRACT

An adjustable support pole for double pane windows including a tubular lower segment. A tubular center segment is provided having an open upper end and an open lower end. The open lower end adjustably receives the lower segment therein. A tubular upper segment is adjustably received within the open upper end of the center segment. An upper end of the upper segment has a horizontal support secured thereto. The horizontal support is positionable under an inner window pane of the double window pane when the inner window pane is disposed in a horizontal orientation.

### BACKGROUND OF THE INVENTION

The present invention relates to an adjustable support pole for double pane windows and more particularly pertains to allowing an outside window pane to be easily cleaned from an interior of a building.

The use of support devices is known in the prior art. More specifically, support devices heretofore devised and utilized for the purpose of providing support to a variety of objects are known to consist basically of familiar, expected and obvious structural configurations, notwithstanding the myriad of designs encompassed by the crowded prior art which have been developed for the fulfillment of countless objectives and requirements.

By way of example, U.S. Pat. No. 2,594,605 to Zoppelt discloses an adjustable support comprised of a telescoping bar, for suspending clothing. U.S. Pat. No. 5,201,488 to Hadbavny discloses a telescoping tubular body with feet attachments, for various automotive purposes. U.S. Pat. No. 4,068,767 to McCarthy discloses a device for supporting plants in a window.

While these devices fulfill their respective, particular objective and requirements, the aforementioned patents do not describe an adjustable support pole for double pane windows for allowing an outside window pane to be easily cleaned from an interior of a building.

In this respect, the adjustable support pole for double pane windows according to the present invention substantially departs from the conventional concepts and designs of the prior art, and in doing so provides an apparatus primarily developed for the purpose of allowing an outside window pane to be easily cleaned from an interior of a building.

Therefore, it can be appreciated that there exists a continuing need for a new and improved adjustable support pole for double pane windows which can be used for allowing an outside window pane to be easily cleaned from an interior of a building. In this regard, the present invention substantially fulfills this need.

### SUMMARY OF THE INVENTION

In the view of the foregoing disadvantages inherent in the known types of support devices now present in the prior art, the present invention provides an improved adjustable support pole for double pane windows. As such, the general purpose of the present invention, which will be described subsequently in greater detail, is to provide a new and improved adjustable support pole for double pane windows which has all the advantages of the prior art and none of the disadvantages.

To attain this, the present invention essentially comprises a tubular lower segment having a closed upper end and a closed lower end. The closed lower end has a rubber stopper disposed thereon. The lower segment has a spring-biased male detent extending outwardly thereof downwardly of the closed upper end thereof. A tubular center segment is provided having an open upper end and an open lower end. The center segment has a plurality of linearly aligned apertures therein in a spaced relationship extending between the open upper and lower ends thereof. The open lower end receives the closed upper end of the lower segment therein with the male detent of the lower segment being selectively received by one of the apertures. A tubular upper segment is provided having a closed upper end and a closed lower end. The upper segment has a spring-biased male detent extending outwardly thereof upwardly of the closed lower end thereof. The closed lower end is received within the open upper end of the center segment with the male detent thereof being selectively received by one of the apertures of the center segment. The closed upper end of the upper segment has a horizontal support secured thereto. The horizontal support is positionable under an inner window pane of the double window pane when the inner window pane is disposed in a horizontal orientation.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved adjustable support pole for double pane windows which has all the advantages of the prior art support devices and none of the disadvantages.

It is another object of the present invention to provide a new and improved adjustable support pole for double pane windows which may be easily and efficiently manufactured and marketed.

It is a further object of the present invention to provide a new and improved adjustable support pole for double pane windows which is of durable and reliable construction.

An even further object of the present invention is to provide a new and improved adjustable support pole for double pane windows which is susceptible of a low cost of manufacture with regard to both materials and labor, and which accordingly is then susceptible of low prices of sale to the consuming public, thereby making such an adjustable support pole for double pane windows economically available to the buying public.

Even still another object of the present invention is to provide a new and improved adjustable support pole for double pane windows for allowing an outside window pane to be easily cleaned from an interior of a building.

Lastly, it is an object of the present invention to provide a new and improved adjustable support pole for double pane windows including a tubular lower segment. A tubular center segment is provided having an open upper end and an open lower end. The open lower end adjustably receives the lower segment therein. A tubular upper segment is adjustably received within the open upper end of the center segment. An upper end of the upper segment has a horizontal support secured thereto. The horizontal support is positionable under an inner window pane of the double window pane when the inner window pane is disposed in a horizontal orientation.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the adjustable support pole for double pane windows constructed in accordance with the principles of the present invention.

FIG. 2 is a perspective view of the present invention illustrated in use.

The same reference numerals refer to the same parts through the various figures.

### DESCRIPTION OF THE PREFERRED EMBODIMENT

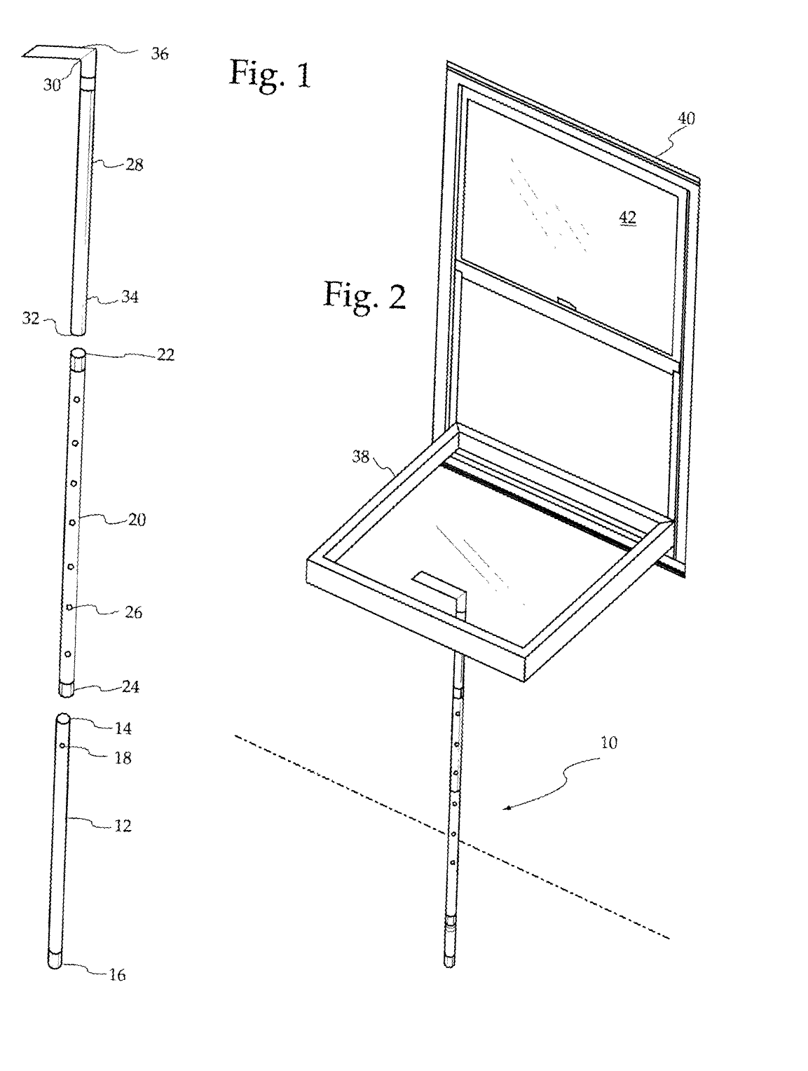

With reference now to the drawings, and in particular, to FIG. 1 through two thereof, the preferred embodiment of the new and improved adjustable support pole for double pane windows embodying the principles and concepts of the present invention and generally designated by the reference number 10 will be described.

Specifically, it will be noted in the various Figures that the device relates to an adjustable support pole for double pane windows for allowing an outside window pane to be easily cleaned from an interior of a building. In its broadest context, the device consists of a tubular lower segment, a tubular center segment, and a tubular upper segment. Such components are individually configured and correlated with respect to each other so as to attain the desired objective.

The tubular lower segment 12 has a closed upper end 14 and a closed lower end 16. The closed lower end 16 has a rubber stopper disposed thereon. The closed lower end 16, when the present invention is in use, will be positioned on a recipient surface. The rubber stopper will present the recipient surface from being scratched, or otherwise damaged. The lower segment 12 has a spring-biased male detent 18 extending outwardly thereof downwardly of the closed upper end 14 thereof.

The tubular center segment 20 has an open upper end 22 and an open lower end 24. The center segment 20 has a plurality of linearly aligned apertures 26 therein in a spaced relationship extending between the open upper and lower ends 22, 24 thereof. The open lower end 24 receives the closed upper end 14 of the lower segment 12 therein with the male detent 18 of the lower segment 12 being selectively received by one of the apertures 26.

The tubular upper segment 28 has a closed upper end 30 and a closed lower end 32. The upper segment 28 has a spring-biased male detent 34 extending outwardly thereof upwardly of the closed lower end 32 thereof. The closed lower end 32 is received within the open upper end 22 of the center segment 20 with the male detent 34 thereof being selectively received by one of the apertures 26 of the center segment 20. The closed upper end 30 of the upper segment 28 has a horizontal support 36 secured thereto. The horizontal support 36 is positionable under an inner window pane 38 of the double window pane 40 when the inner window pane 38 is disposed in a horizontal orientation. Note figure two. When the inner window pane 38 is lowered to its horizontal orientation, the present invention is positioned thereunder to prevent the inner window pane 38 from moving any further. Thus, the outer window pane 42 can be lowered and easily cleaned without the user having to worry about dropping or damaging the inner window pane 38 due to the presence of the present invention. The adjustability of the present invention allows for its use in a variety of locations whereby an inner window pane can be lowered and held in the horizontal orientation for the cleaning of the outer window pane.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modification and changes will readily occur to those skilled in the art, it is not desired to limit the invention to the exact construction and operation shown and described, and accordingly, all suitable modification and equivalents may be resorted to, falling within the scope of the invention.

What is claimed as being new and desired to be protected by Letters Patent of the United States is as follows:

1. An adjustable support pole for double pane windows for allowing an outside window pane to be easily cleaned from an interior of a building comprising, in combination:
a tubular lower segment having a closed upper end and a closed lower end, the closed lower end having a rubber stopper disposed thereon, the lower segment having a spring-biased male detent extending outwardly thereof downwardly of the closed upper end thereof;
a tubular center segment having an open upper end and an open lower end, the center segment having a plurality of linearly aligned apertures therein in a spaced relationship extending between the open upper and lower ends thereof, the open lower end receiving the closed upper end of the lower segment therein with the male detent of the lower segment being selectively received by one of the apertures; and
a tubular upper segment having a closed upper end and a closed lower end, the upper segment having a spring-biased male detent extending outwardly thereof upwardly of the closed lower end thereof, the closed lower end being received within the open upper end of the center segment with the male detent thereof being selectively received by one of the apertures of the center segment, the closed upper end of the upper segment having a horizontal support secured thereto, the horizontal support being positionable under an inner window pane of the double window pane when in the inner window pane is disposed in a horizontal orientation.

2. An adjustable support pole for double pane windows for allowing an outside window pane to be easily cleaned from an interior of a building comprising, in combination:
a tubular lower segment;
a tubular center segment having an open upper end and an open lower end, the open lower end adjustably receiving the lower segment therein; and
a tubular upper segment being adjustably received within the open upper end of the center segment, an upper end of the upper segment having a horizontal support secured thereto, the horizontal support being positionable under an inner window pane of the double window pane when in the inner window pane is disposed in a horizontal orientation.
